(19) United States
(12) Patent Application Publication
(10) Pub. No.: US 2024/0031680 A1
(43) Pub. Date: Jan. 25, 2024

(54) MACHINE LEARNING-BASED CAMERA POSITIONING

(71) Applicant: FARO Technologies, Inc., Lake Mary, FL (US)

(72) Inventors: Tharesh SHARMA, Waiblingen (DE); Georgios BALATZIS, Fellbach (DE)

(21) Appl. No.: 18/337,900

(22) Filed: Jun. 20, 2023

Related U.S. Application Data
(60) Provisional application No. 63/390,531, filed on Jul. 19, 2022.

(51) Int. Cl. H04N 23/695; G06V 10/20; G06V 10/82; G06T 7/70

(52) U.S. Cl. CPC H04N 23/695; G06V 10/255; G06V 10/82; G06T 7/70

(57) ABSTRACT

Examples described herein provide a computer-implemented method that includes receiving a video stream from a camera. The method further includes detecting, within the video stream, an object of interest using a first trained machine learning model. The method further includes, responsive to determining that a confidence score associated with the object of interest fails to satisfy a threshold, determining, using a second trained machine learning model, a direction to move the camera to cause the confidence score to satisfy the threshold. The method further includes presenting an indication of the direction to move the camera to cause the confidence score to satisfy the threshold.

### CROSS-REFERENCE TO RELATED APPLICATION

This application claims the benefit of U.S. Provisional Application No. 63/390,531, filed Jul. 19, 2022, and entitled “MACHINE LEARNING-BASED CAMERA POSITIONING,” the contents of which is incorporated herein by reference in its entirety.

### BACKGROUND

The subject matter disclosed herein relates to artificial intelligence, and in particular to machine learning-based camera positioning.

Metrology devices that measure three-dimensional coordinates of an environment often use an optical process for acquiring coordinates of surfaces. Metrology devices of this category include, but are not limited to time-of-flight (TOF) laser scanners, laser trackers, laser line probes, photogrammetry devices, triangulation scanners, structured light scanners, or systems that use a combination of the foregoing. Typically, these devices include a two-dimensional (2D) camera to acquire images, either before, during or after the acquisition of three-dimensional coordinates (commonly referred to as scanning). The 2D camera acquires a 2D image, meaning an image that lacks depth information.

Three-dimensional measurement devices use the 2D image for a variety of functions. These can include colorizing a collection of three-dimensional coordinates, sometimes referred to as a point cloud, performing supplemental coordinate measurements (e.g. photogrammetry), identify features or recognize objects in the environment, register the point cloud, and the like. Since these 2D cameras have a narrow field of view relative to the volume being scanned or the field of operation, many images are acquired to obtain the desired information. It should be appreciated that this acquisition of 2D images and the subsequent merging of this information adds to the amount of time to complete the scan of the environment.

Accordingly while existing cameras are suitable for their intended purposes the need for improvement remains, particularly in providing a system and method having the features described herein.

### BRIEF DESCRIPTION

In one exemplary embodiment, a method is provided. The method includes receiving a video stream from a camera. The method further includes detecting, within the video stream, an object of interest using a first trained machine learning model. The method further includes, responsive to determining that a confidence score associated with the object of interest fails to satisfy a threshold, determining, using a second trained machine learning model, a direction to move the camera to cause the confidence score to satisfy the threshold. The method further includes presenting an indication of the direction to move the camera to cause the confidence score to satisfy the threshold.

In addition to one or more of the features described herein, or as an alternative, further embodiments of the method may include that the camera is a 360 degree image acquisition system.

In addition to one or more of the features described herein, or as an alternative, further embodiments of the method may include that the 360 degree image acquisition system includes: a first photosensitive array operably coupled to a first lens, the first lens having a first optical axis in a first direction, the first lens being configured to provide a first field of view greater than 180 degrees; a second photosensitive array operably coupled to a second lens, the second lens having a second optical axis in a second direction, the second direction is opposite the first direction, the second lens being configured to provide a second field of view greater than 180 degrees; and wherein the first field of view at least partially overlaps with the second field of view.

In addition to one or more of the features described herein, or as an alternative, further embodiments of the method may include that the first optical axis and the second optical axis are coaxial.

In addition to one or more of the features described herein, or as an alternative, further embodiments of the method may include that the first photosensitive array is positioned adjacent the second photosensitive array.

In addition to one or more of the features described herein, or as an alternative, further embodiments of the method may include that the first trained machine learning model is a convolutional neural network.

In addition to one or more of the features described herein, or as an alternative, further embodiments of the method may include that the second trained machine learning model is trained to minimize a distance between a center point of a field of view of the camera and a centroid of a bounding box circumscribing the object of interest.

In addition to one or more of the features described herein, or as an alternative, further embodiments of the method may include that the direction is based on the distance.

In addition to one or more of the features described herein, or as an alternative, further embodiments of the method may include: training the first trained machine learning model to detect the object of interest; and training the second trained machine learning model the direction to move the camera.

In addition to one or more of the features described herein, or as an alternative, further embodiments of the method may include that the second trained machine learning model uses a Gaussian measure tree.

In addition to one or more of the features described herein, or as an alternative, further embodiments of the method may include that the second trained machine learning model uses a support vector tree.

In another exemplary embodiment a system is provided. The system includes a camera to capture a video stream of an environment. The system further includes a processing system communicatively coupled to the camera. The processing system includes a memory having computer readable instructions. The processing system further includes a processing device for executing the computer readable instructions. The computer readable instructions control the processing device to perform operations. The operations include receiving the video stream from the camera. The operations further include detecting, within the video stream, an object of interest using a first trained machine learning model. The operations further include, responsive to determining that a confidence score associated with the object of interest fails to satisfy a threshold, determining, using a second trained machine learning model, a direction to move the camera to cause the confidence score to satisfy the threshold. The operations further include presenting an indication of the direction to move the camera to cause the confidence score to satisfy the threshold.

In addition to one or more of the features described herein, or as an alternative, further embodiments of the system may include that the camera is a 360 degree image acquisition system that includes: a first photosensitive array operably coupled to a first lens, the first lens having a first optical axis in a first direction, the first lens being configured to provide a first field of view greater than 180 degrees; a second photosensitive array operably coupled to a second lens, the second lens having a second optical axis in a second direction, the second direction is opposite the first direction, the second lens being configured to provide a second field of view greater than 180 degrees; wherein the first field of view at least partially overlaps with the second field of view, wherein the first optical axis and the second optical axis are coaxial, and wherein the first photosensitive array is positioned adjacent the second photosensitive array.

In addition to one or more of the features described herein, or as an alternative, further embodiments of the system may include that the first trained machine learning model is a convolutional neural network.

In addition to one or more of the features described herein, or as an alternative, further embodiments of the system may include that the second trained machine learning model is trained to minimize a distance between a center point of a field of view of the camera and a centroid of a bounding box circumscribing the object of interest.

In addition to one or more of the features described herein, or as an alternative, further embodiments of the system may include that the direction is based on the distance.

In addition to one or more of the features described herein, or as an alternative, further embodiments of the system may include that the second trained machine learning model uses a Gaussian measure tree.

In addition to one or more of the features described herein, or as an alternative, further embodiments of the system may include that the second trained machine learning model uses a support vector tree.

In another exemplary embodiment a camera is provided. The camera includes a first photosensitive array operably coupled to a first lens, the first lens having a first optical axis in a first direction, the first lens being configured to provide a first field of view greater than 180 degrees. The camera further includes a second photosensitive array operably coupled to a second lens, the second lens having a second optical axis in a second direction, the second direction is opposite the first direction, the second lens being configured to provide a second field of view greater than 180 degrees. The first field of view at least partially overlaps with the second field of view. The camera further includes a field programmable gate array. The field programmable gate array detects, within a video stream captured by the camera, an object of interest using a first trained machine learning model. The field programmable gate array determines whether a confidence score associated with the object of interest satisfies satisfy a threshold. The field programmable gate array determines, using a second trained machine learning model, a direction to move the camera to cause the confidence score to satisfy the threshold responsive to determining that the confidence score fails to satisfy the threshold. The field programmable gate array presents an indication of the direction to move the camera to cause the confidence score to satisfy the threshold.

In addition to one or more of the features described herein, or as an alternative, further embodiments of the camera may include that the second trained machine learning model is trained to minimize a distance between a center point of a field of view of the camera and a centroid of a bounding box circumscribing the object of interest, and wherein the direction is based on the distance.

The above features and advantages, and other features and advantages, of the disclosure are readily apparent from the following detailed description when taken in connection with the accompanying drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a schematic block diagram of system to perform machine learning-based camera positioning according to one or more embodiments described herein;

FIG. 1B is a schematic view of an omnidirectional camera for use with the processing system of FIG. 1A according to one or more embodiments described herein;

FIG. 1C is a schematic view of an omnidirectional camera system with a dual camera for use with the processing system of FIG. 1A according to one or more embodiments described herein;

FIG. 1D and FIG. 1E are images acquired by the dual camera of FIG. 1C according to one or more embodiments described herein;

FIG. 1D′ and FIG. 1E′ are images of the dual camera of FIG. 1C where each of the images has a field of view greater than 180 degrees according to one or more embodiments described herein;

FIG. 1F is a merged image formed from the images of FIG. 1D and FIG. 1E in accordance with an embodiment according to one or more embodiments described herein;

FIG. 2A is a schematic block diagram of a system having the camera and processing system of FIG. 1, the system to perform machine learning-based camera positioning according to one or more embodiments described herein;

FIG. 2B is a schematic block diagram of the camera of FIG. 1A having a field programmable gate array to perform machine learning-based camera positioning according to one or more embodiments described herein;

FIG. 3 is a flow diagram of a method for performing machine learning-based camera positioning according to one or more embodiments described herein;

FIG. 4 depicts a block diagram of components of a machine learning training and inference system according to one or more embodiments described herein; and

FIG. 5 depicts a block diagram of a processing system for implementing one or more embodiments described herein.

The detailed description explains embodiments of the disclosure, together with advantages and features, by way of example with reference to the drawings.

### DETAILED DESCRIPTION OF THE DISCLOSURE

Embodiments of the present disclosure provide for performing machine learning-based camera positioning, such as for an ultra-wide angle camera. Ultra-wide angle cameras can be used, for example, to capture 360 degree images of an environment. Conventionally, the 360 degree images are captured and then processed for detecting and/or identifying objects of interest within the environment. Frequently, not all objects of interest contained in the 360-degree image are discernible, and additional 360 degrees images might be needed to identify some of the objects of interest.

In an effort to address these and other shortcomings of the prior art, one or more embodiments are provided herein for performing machine learning-based camera positioning. According to an embodiment, a video stream is captured using a camera, such as an ultra-wide angle camera. Within the video stream, an object of interest is detected using a first trained machine learning model. It can then be determined, using a second trained machine learning model, a direction to move the camera to cause a confidence score associated with the object of interest to satisfy a threshold. This approach produces captured images having higher data density and accuracy than conventional approaches, which provides for more accurate object detection and better results for documentation.

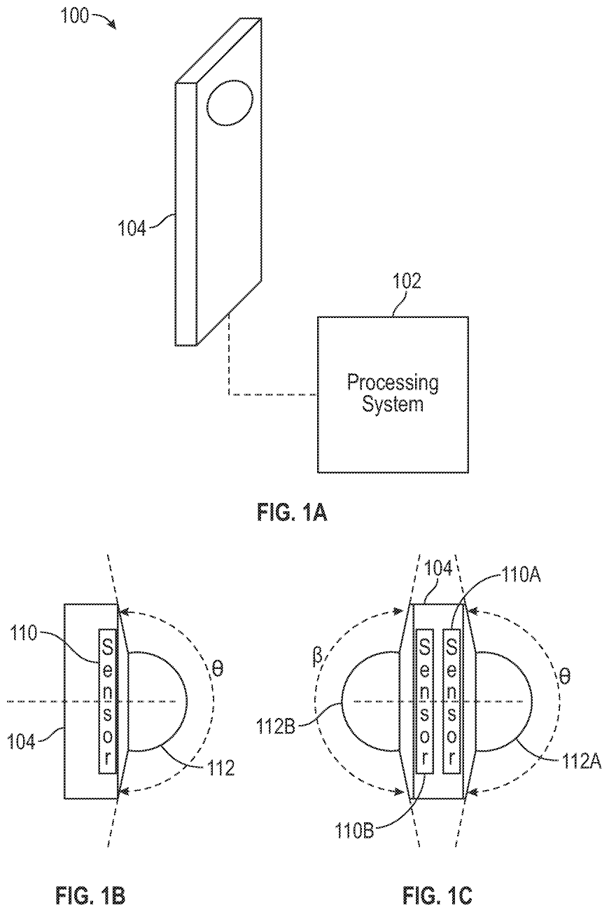

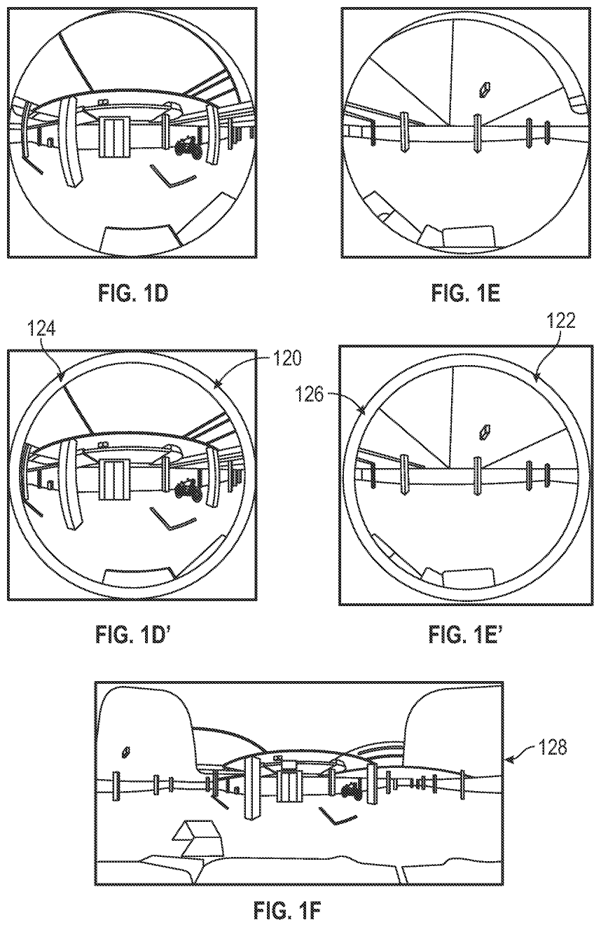

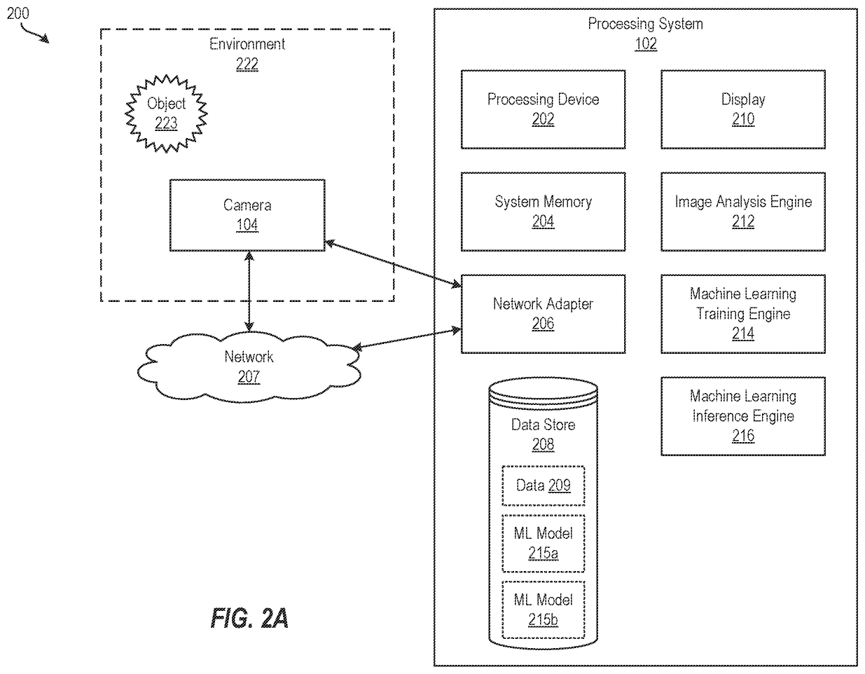

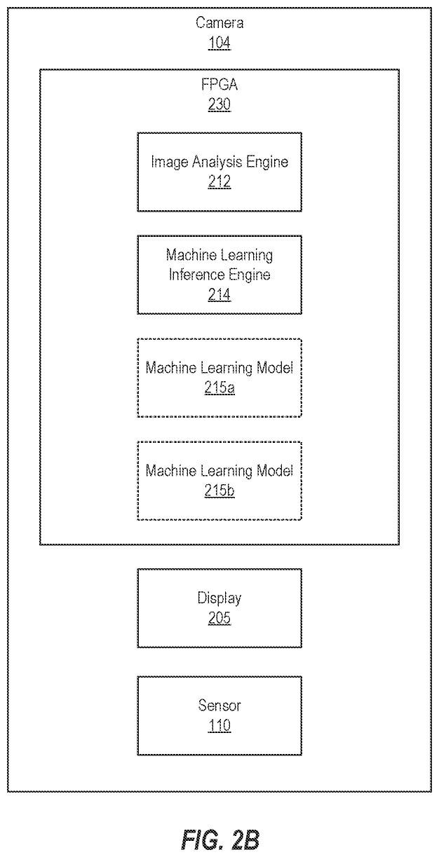

Referring now to FIGS. 1A-1C, an embodiment is shown of a system 100 for performing machine learning-based camera positioning according to one or more embodiments described herein. Particularly, FIG. 1A depicts a system 100 to generate a digital twin representation of an environment or object, the system having a camera 104 for capturing images (e.g., a video stream) and a processing system 102 having processing capabilities for processing the images/video stream. As an example, the processing system 102 can be a smartphone, laptop computer, tablet computer, and/or the like, including combinations and/or multiples thereof. As an example, the camera 104 can be an omnidirectional camera, such as the RICO THETA camera. The processing system 102 can include one or more engines, such as for performing image analysis, machine learning model training, machine learning model inference, and/or the like (see, e.g. FIG. 2A).

The processing system 102 can be any suitable processing system, such as a smartphone, tablet computer, laptop or notebook computer, etc. The processing system 102 can include one or more additional components, such as a processing device for executing instructions, a memory for storing instructions and/or data, a display for displaying user interfaces, an input device for receiving inputs, an output device for generating outputs, a communications adapter for facilitating communications with other devices (e.g., the camera 104), and/or the like including combinations and/or multiples thereof. One example configuration of the processing system 102 is shown in FIG. 2A.

With continued reference to FIGS. 1A-1C, the camera 104 captures one or more images, such as a panoramic image, of an environment. In examples, the camera 104 can be an ultra-wide angle camera 104. In an embodiment, the camera 104 includes a sensor 110 (FIG. 1B), that includes an array of photosensitive pixels. The sensor 110 is arranged to receive light from a lens 112. In the illustrated embodiment, the lens 112 is an ultra-wide angle lens that provides (in combination with the sensor 110) a field of view θ between 100 and 270 degrees, for example. In an embodiment, the field of view θ is greater than 180 degrees and less than 270 degrees about a vertical axis (e.g., substantially perpendicular to the floor or surface that the measurement device is located). It should be appreciated that while embodiments herein describe the lens 112 as a single lens, this is for example purposes and the lens 112 may be a comprised of a plurality of optical elements.

In an embodiment, the camera 104 includes a pair of sensors 110A, 110B that are arranged to receive light from ultra-wide angle lenses 112A, 112B respectively (FIG. 1C). In this example, the camera 104 can be referred to as a dual camera because it has a pair of sensors 110A, 110B and lenses 112A, 112B as shown. The sensor 110A and lens 112A are arranged to acquire images in a first direction, and the sensor 110B and lens 112B are arranged to acquire images in a second direction. In the illustrated embodiment, the second direction is opposite the first direction (e.g., 180 degrees apart). A camera having opposingly arranged sensors and lenses with at least 180 degree field of view are sometimes referred to as an omnidirectional camera, a 360 degree camera, or a panoramic camera as it acquires an image in a 360 degree volume about the camera.

FIGS. 1D and 1E depict images acquired by the dual camera of FIG. 1C, for example, and FIGS. 1D′ and 1E′ depict images acquired the dual camera of FIG. 1C where each of the images has a field of view greater than 180 degrees. It should be appreciated that when the field of view is greater than 180 degrees, there will be an overlap 120, 122 between the acquired images 124, 126 as shown in FIG. 1D′ and FIG. 1E′. In some embodiments, the images may be combined to form a single image 128 of at least a substantial portion of the spherical volume about the camera 104 as shown in FIG. 1F.

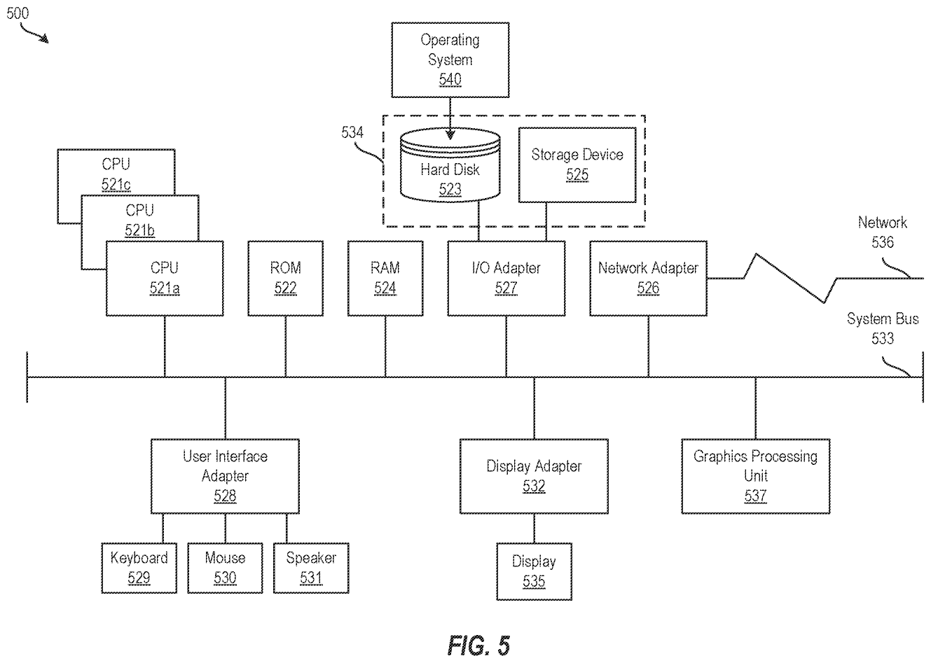

Referring now to FIG. 2A, a schematic block diagram is shown of a system 200 having the camera 104 and processing system 102 of FIG. 1A, the system 200 to perform machine learning-based camera positioning according to one or more embodiments described herein. The processing system 200 includes a processing device 202 (e.g., one or more of the processing devices 521 of FIG. 5), a system memory 204 (e.g., the RAM 524 and/or the ROM 522 of FIG. 5), a network adapter 206 (e.g., the network adapter 526 of FIG. 5), a data store 208, a display 210, an image analysis engine 212, a machine learning training engine 214, and a machine learning inference engine 216.

The various components, modules, engines, etc. described regarding FIG. 2A (e.g., the image analysis engine 212, the machine learning training engine 214, and the machine learning inference engine 216) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 202 for executing those instructions. Thus, the system memory 204 can store program instructions that when executed by the processing device 202 implement the engines described herein. Other engines can also be utilized to include other features and functionality described in other examples herein. As another example, the camera 104 can include an FPGA 230 (or another similarly suitable special-purpose hardware device) that can implement the features and functions of the image analysis engine 212 and the machine learning inference engine 216 using the machine learning models 215a, 215b.

With continued reference to FIG. 2A, the network adapter 206 enables the processing system 200 to transmit data and/or images to and/or receive data and/or images from other sources, such as the camera 104. For example, the processing system 200 receives data (e.g., images of an environment 522) from the camera 104 directly and/or via a network 207. The images from the camera 104 can be stored in the data store 208 of the processing system 200 as data 509.

The network 207 represents any one or a combination of different types of suitable communications networks such as, for example, cable networks, public networks (e.g., the Internet), private networks, wireless networks, cellular networks, or any other suitable private and/or public networks. Further, the network 207 can have any suitable communication range associated therewith and may include, for example, global networks (e.g., the Internet), metropolitan area networks (MANs), wide area networks (WANs), local area networks (LANs), or personal area networks (PANs). In addition, the network 207 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In one or more embodiments, one or more of the components of the processing system 200 can be implemented using distributed or cloud computing techniques. For example, a cloud computing system can be in wired or wireless electronic communication with one or more of the elements of the processing system 200. Cloud computing can supplement, support or replace some or all of the functionality of the elements of the processing system 200. Additionally, some or all of the functionality of the elements of the processing system 200 (e.g., the image analysis engine 212, the machine learning training engine 214, and/or the machine learning inference engine 216) can be implemented as a node of a cloud computing system. A cloud computing node is only one example of a suitable cloud computing node and is not intended to suggest any limitation as to the scope of use or functionality of embodiments described herein. For example, the network 207 can be a cloud network. According to one or more embodiments described herein, edge computing can be implemented, such that one or more edge devices can perform one or more of the features and/or functions of the processing system 200. For example, as shown in FIG. 2B, the camera 104 can be an edge processing device, which can perform image analysis and/or inference by the image analysis engine 212 and/or the machine learning inference engine 216 using the machine learning models 215a, 215b.

The camera 104 (e.g., an omnidirectional camera, a panoramic camera, etc.) can be arranged on, in, and/or around the environment 222 to capture one or more images of or within the environment 222. The camera 104 captures one or more images, such as a video stream, of the environment 222. The images (e.g., the video stream) can be transmitted, directly or indirectly (such as via the network 507) to a processing system (such as the processing system 200), which can store the data set as the data 209 in the data store 208. It should be appreciated that other numbers of cameras (e.g., one scanner, two scanners, three scanners, four scanners, six scanners, eight scanners, twelve scanners, etc.) can be used.

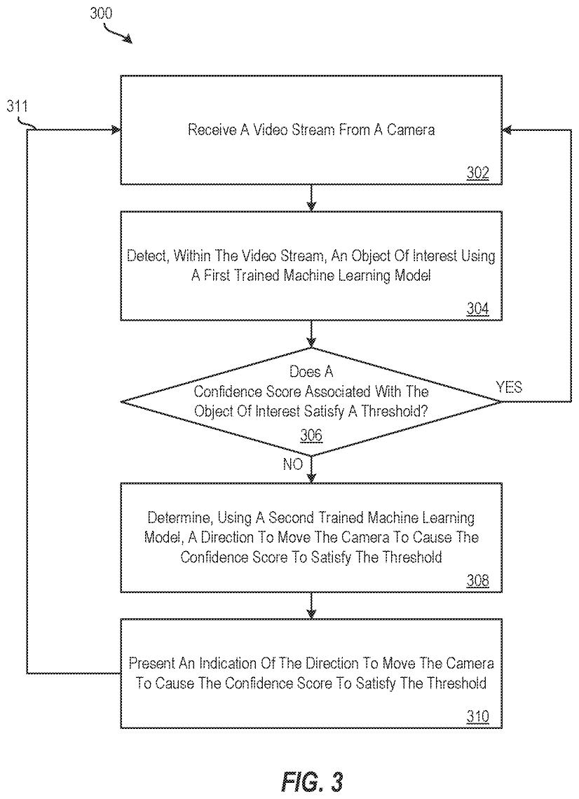

The images (e.g., the video stream) can be used to perform image analysis, which can include detecting an object of interest within an image (e.g., video stream). Performing the image analysis can include determining a direction to move the camera 104 to increase detection accuracy for objects of interest having a low detection accuracy (e.g., where a confidence score associated with an object of interest fails to satisfy a threshold). The features and functionality of the image analysis engine 212, the machine learning training engine 214, and the machine learning inference engine 216 are now described in more detail with reference to FIG. 3.

Particularly, FIG. 3 depicts a flow diagram of a method 300 for performing machine learning-based camera positioning according to one or more embodiments described herein. The method 300 can be performed by any suitable system and/or device such as the processing system 102, the camera 104, and/or the like, including combinations and/or multiples thereof.

At block 302, a processing system (e.g., the processing system 102) receives a video stream from a camera (e.g., the camera 104). For example, the camera 104 captures images of the environment 222 and transmits them to the processing system 102 as a stream of images (i.e., a video stream).

At block 304, the processing system 102 (e.g., using the image analysis engine 212 and the machine learning inference engine 216) detects, within the video stream, an object of interest using a first trained machine learning model (e.g., the machine learning model 215a). The machine learning model 215a can be trained to detect and classify one or more objects (i.e., an object of interest) in an image such as the video stream. The machine learning training engine 212 can be trained using supervised learning, for example, using a collection of training data that contain images of objects of interest (e.g., a chair, a window, a dog, etc.) and labels associated with the objects of interest (e.g., “chair”, “window,” “dog” etc. respectively. According to one or more embodiments described herein, the machine learning model 215a is a convolutional neural network trained to detect and classify one or more objects in an image such as the video stream. According to one or more embodiments described herein, the image analysis engine 212 can extract a region of interest containing the object of interest from the video feed, then the machine learning model 215a can detect and classify the object of interest from within the region of interest.

As part of the detection and classification of objects of interest, the processing system 102 can determine a confidence score for each detected object of interest. The confidence score is a number within a range (e.g., [0,100], [0.0,1.0], etc.) that indicates how confident the machine learning model 215a is with its classification. For example, a higher confidence score may indicate a higher confidence with a classification, while a lower confidence score may indicate a lower confidence. The confidence score can be indicative accuracy of object detection, which can be dependent on the image of the object of interest. As an example, a first image of the object of interest taken farther away from the object of interest relative to a second image of the object of interest taken closer to the object of interest may have a lower confidence score than a confidence score for the second image.

At decision block 306, the processing system 102 (e.g., using the image analysis engine 212) determines whether the confidence score associated with the object of interest satisfies a threshold. For example, a threshold can be set such that any confidence scores that meet the threshold are considered to satisfy the threshold while any confidence scores that fail to meet the threshold are considered not to satisfy the threshold. If it is determined at decision block 306 that the confidence score for a particular object of interest satisfies the threshold, the method 300 returns to block 302 and repeats.

If, at decision block 306 it is determined that the confidence score for the object of interest fails to satisfy the threshold, the method 300 continues to block 308. This determination may indicate that the camera 104 needs to be repositioned/moved within the environment 522 relative to the object of interest. At block 308, the processing system 102 determines, using a second trained machine learning model (e.g., the machine learning model 215b), a direction to move the camera 104 to cause the confidence score to satisfy the threshold.

The machine learning model 215b can be trained using marked images. Marked images contain a mark or indication at a zero point of the field of view of the camera 104 (e.g., a center point of the field of view). The machine learning model 215b is trained to reduce the distance between the object of interest and the zero point of the field of view of the camera 104. For example, the image analysis engine 212 can determine a center point of a view of view of the camera 104. The image analysis engine 212 can also determine a centroid of a bounding box that circumscribes the object of interest. The machine learning model 215b can be trained to determine the direction to move the camera in order to minimize the distance between the centroid of the bounding box and the center point of the field of view of the camera 104. According to one or more embodiments described herein, the machine learning model 215b implements a gaussian measure tree, a support vector tree, or another suitable framework for determining the distance. According to one or more embodiments described herein, the direction to move the camera 104 is based on the confidence score such that the camera 104 need only be moved enough to increase the confidence score to satisfy the threshold. Thus, in examples, the movement of the camera 104 need not necessarily cause the distance between the centroid of the bounding box and the center point of the field of view of the camera 104 to be at or near zero. Rather, in some cases, merely moving the camera 104 to reduce the distance may be enough to increase the confidence score to satisfy the threshold.

The direction to move the camera 104 can be relative to a local coordinate system, a world coordinate system, or some other frame of reference. The direction can be one or more of a change in location (e.g., a change in x, y, z in a 3D coordinate space) of the camera 104 and/or a change in orientation (e.g., a change in roll, pitch, yaw in a 3D coordinate space) and/or the like. For example, a direction could be to move north three meters, to rotate right 25 degrees, to pan down 15 degrees, to move left one meter, and/or the like, including combinations and/or multiples thereof (e.g., move southwest one meter and rotate right 20 degrees).

Once the distance is determined at block 308, the method 300 proceeds to block 310, where an indication of the direction to move the camera is presented. The indication can be presented on the display 210 of the processing system 102, on a display 205 of the camera 104 (see, e.g., FIG. 2B), and/or on another suitable display. In examples, the indication can be audible, such as a verbal instruction on how to move the camera (e.g., “Move the camera one meter to the right.”). According to one or more embodiments described herein, the display 205 on the camera 104 can display a compass used to indicate how to move the camera 104 based on the determination at block 308.

According to one or more embodiments described herein, once the indication of the direction is presented at block 310 and the camera is moved, the method 300 can end or can restart at block 302 as shown by the arrow 311.

Additional processes also may be included, and it should be understood that the process depicted in FIG. 3 represents an illustration, and that other processes may be added or existing processes may be removed, modified, or rearranged without departing from the scope of the present disclosure.

One or more embodiments described herein can utilize machine learning techniques to perform tasks, such as to perform machine learning-based camera positioning. More specifically, one or more embodiments described herein can incorporate and utilize rule-based decision making and artificial intelligence (AI) reasoning to accomplish the various operations described herein, namely performing machine learning-based camera positioning. The phrase “machine learning” broadly describes a function of electronic systems that learn from data. A machine learning system, engine, or module can include a trainable machine learning algorithm that can be trained, such as in an external cloud environment, to learn functional relationships between inputs and outputs that are currently unknown, and the resulting model (sometimes referred to as a “trained neural network,” “trained model,” and/or “trained machine learning model”) can be used for performing machine learning-based camera positioning, for example. In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANN that are particularly useful at analyzing visual imagery.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of performing machine learning-based camera positioning as described herein.

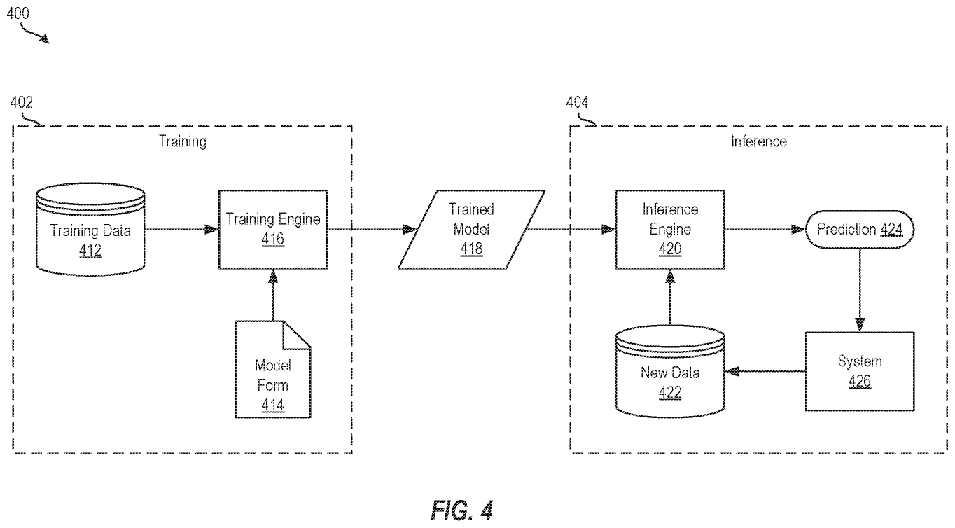

Systems for training and using a machine learning model are now described in more detail with reference to FIG. 4. Particularly, FIG. 4 depicts a block diagram of components of a machine learning training and inference system 400 according to one or more embodiments described herein. The system 400 performs training 402 and inference 404. During training 402, a training engine 416 trains a model (e.g., the trained model 418, which may be one or more of the machine learning models 215a, 215b) to perform a task or tasks. An example of such a task is to detect and classify one or more objects (i.e., an object of interest) in an image such as the video stream (e.g., the machine learning model 215a). Another example of such a task is to reduce the distance between an object of interest and a zero point of a field of view of a camera (e.g., the machine learning model 215b). Inference 404 is the process of implementing the trained model 418 to perform one or more of these tasks, such as to use the machine learning model 215a to perform object detection and classification and/or to use the machine learning model 215b to reduce the distance between the object of interest and the zero point of the field of view of the camera in the context of a larger system (e.g., a system 426), such as the camera 102.

The training 402 begins with training data 412, which may be structured or unstructured data. According to one or more embodiments described herein, the training data 412 includes unstructured data in the form of images having associated labels for training the machine learning model 215a. According to one or more embodiments described herein, the training data 412 includes images and object depth information associated therewith. The machine learning model 215a is trained to identify a correct position in the image. After having trained the machine learning model 215a with the images and object depth information, the detection of objects can be performed in an optimal way at an optimized location in the image. Using this information, the position of the camera can be provided to a user, where the position identifies an optimized location to take images. The training engine 416 receives the training data 412 and a model form 414. The model form 414 represents a base model that is untrained. The model form 414 can have preset weights and biases, which can be adjusted during training. It should be appreciated that the model form 414 can be selected from many different model forms depending on the task to be performed. For example, where the training 402 is to train a model to perform image classification, the model form 414 may be a model form of a CNN. The training 402 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 412 includes labeled images, including images of the object of interest with associated labels (ground truth) and other images that do not include the object of interest with associated labels. The training engine 416 takes as input a training image, makes a prediction for classifying the image, and compares the prediction to the known label. The training engine 416 then adjusts weights and/or biases of the model based on results of the comparison, such as by using backpropagation. The training 402 may be performed multiple times (referred to as “epochs”) until a suitable model is trained (e.g., the trained model 418).

Once trained, the trained model 418 can be used to perform inference 404 to perform a task, such as to such as to use the machine learning model 215a to perform object detection and classification and/or to use the machine learning model 215b to reduce the distance between the object of interest and the zero point of the field of view of the camera. The inference engine 420 applies the trained model 418 to new data 422 (e.g., real-world, non-training data). For example, if the trained model 418 is trained to classify images of a particular object, such as a chair, the new data 422 can be an image of a chair that was not part of the training data 412. In this way, the new data 422 represents data to which the model trained 418 has not been exposed. The inference engine 420 makes a prediction 424 (e.g., a classification of an object in an image of the new data 422) and passes the prediction 424 to the system 426 (e.g., the system 100, the system 200, the camera 104 of FIG. 2B). The system 426 can, based on the prediction 424, taken an action, perform an operation, perform an analysis, and/or the like, including combinations and/or multiples thereof. In some embodiments, the system 426 can add to and/or modify the new data 422 based on the prediction 424.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node. In examples, processing system 500 has one or more central processing units (“processors” or “processing resources” or “processing devices”) 521a, 521b, 521c, etc. (collectively or generically referred to as processor(s) 521 and/or as processing device(s)). In aspects of the present disclosure, each processor 521 can include a reduced instruction set computer (RISC) microprocessor. Processors 521 are coupled to system memory (e.g., random access memory (RAM) 524) and various other components via a system bus 533. Read only memory (ROM) 522 is coupled to system bus 533 and may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 523 and/or a storage device 525 or any other similar component. I/O adapter 527, hard disk 523, and storage device 525 are collectively referred to herein as mass storage 534. Operating system 540 for execution on processing system 500 may be stored in mass storage 534. The network adapter 526 interconnects system bus 533 with an outside network 536 enabling processing system 500 to communicate with other such systems.

A display 535 (e.g., a display monitor) is connected to system bus 533 by display adapter 532, which may include a graphics adapter to improve the performance of graphics intensive applications and a video controller. In one aspect of the present disclosure, adapters 526, 527, and/or 532 may be connected to one or more I/O busses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including system memory (e.g., RAM 524), and mass storage 534, input means such as keyboard 529 and mouse 530, and output capability including speaker 531 and display 535. In some aspects of the present disclosure, a portion of system memory (e.g., RAM 524) and mass storage 534 collectively store the operating system 540 to coordinate the functions of the various components shown in processing system 500.

The term “about” is intended to include the degree of error associated with measurement of the particular quantity based upon the equipment available at the time of filing the application.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.” It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method comprising:
receiving a video stream from a camera;
detecting, within the video stream, an object of interest using a first trained machine learning model;
responsive to determining that a confidence score associated with the object of interest fails to satisfy a threshold, determining, using a second trained machine learning model, a direction to move the camera to cause the confidence score to satisfy the threshold; and
presenting an indication of the direction to move the camera to cause the confidence score to satisfy the threshold.

2. The method of claim 1, wherein the camera is a 360 degree image acquisition system.

3. The method of claim 2, wherein, the 360 degree image acquisition system comprises:
a first photosensitive array operably coupled to a first lens, the first lens having a first optical axis in a first direction, the first lens being configured to provide a first field of view greater than 180 degrees;
a second photosensitive array operably coupled to a second lens, the second lens having a second optical axis in a second direction, the second direction is opposite the first direction, the second lens being configured to provide a second field of view greater than 180 degrees; and
wherein the first field of view at least partially overlaps with the second field of view.

4. The method of claim 3, wherein the first optical axis and the second optical axis are coaxial.

5. The method of claim 3, wherein the first photosensitive array is positioned adjacent the second photosensitive array.

6. The method of claim 1, wherein the first trained machine learning model is a convolutional neural network.

7. The method of claim 1, wherein the second trained machine learning model is trained to minimize a distance between a center point of a field of view of the camera and a centroid of a bounding box circumscribing the object of interest.

8. The method of claim 7, wherein the direction is based on the distance.

9. The method of claim 1, further comprising:
training the first trained machine learning model to detect the object of interest; and
training the second trained machine learning model the direction to move the camera.

10. The method of claim 1, wherein the second trained machine learning model uses a Gaussian measure tree.

11. The method of claim 1, wherein the second trained machine learning model uses a support vector tree.

12. A system comprising:
a camera to capture a video stream of an environment; and
a processing system communicatively coupled to the camera, the processing system comprising:
a memory comprising computer readable instructions; and
a processing device for executing the computer readable instructions, the computer readable instructions controlling the processing device to perform operations comprising:
receiving the video stream from the camera;
detecting, within the video stream, an object of interest using a first trained machine learning model;
responsive to determining that a confidence score associated with the object of interest fails to satisfy a threshold, determining, using a second trained machine learning model, a direction to move the camera to cause the confidence score to satisfy the threshold; and
presenting an indication of the direction to move the camera to cause the confidence score to satisfy the threshold.

13. The system of claim 12, wherein the camera is a 360 degree image acquisition system that comprises:
a first photosensitive array operably coupled to a first lens, the first lens having a first optical axis in a first direction, the first lens being configured to provide a first field of view greater than 180 degrees;
a second photosensitive array operably coupled to a second lens, the second lens having a second optical axis in a second direction, the second direction is opposite the first direction, the second lens being configured to provide a second field of view greater than 180 degrees;
wherein the first field of view at least partially overlaps with the second field of view,
wherein the first optical axis and the second optical axis are coaxial, and
wherein the first photosensitive array is positioned adjacent the second photosensitive array.

14. The system of claim 12, wherein the first trained machine learning model is a convolutional neural network.

15. The system of claim 12, wherein the second trained machine learning model is trained to minimize a distance between a center point of a field of view of the camera and a centroid of a bounding box circumscribing the object of interest.

16. The system of claim 15, wherein the direction is based on the distance.

17. The system of claim 12, wherein the second trained machine learning model uses a Gaussian measure tree.

18. The system of claim 12, wherein the second trained machine learning model uses a support vector tree.

19. A camera comprising:
a first photosensitive array operably coupled to a first lens, the first lens having a first optical axis in a first direction, the first lens being configured to provide a first field of view greater than 180 degrees;
a second photosensitive array operably coupled to a second lens, the second lens having a second optical axis in a second direction, the second direction is opposite the first direction, the second lens being configured to provide a second field of view greater than 180 degrees, wherein the first field of view at least partially overlaps with the second field of view; and
a field programmable gate array to:
detect, within a video stream captured by the camera, an object of interest using a first trained machine learning model;
determine whether a confidence score associated with the object of interest satisfies satisfy a threshold,
determine, using a second trained machine learning model, a direction to move the camera to cause the confidence score to satisfy the threshold responsive to determining that the confidence score fails to satisfy the threshold; and
present an indication of the direction to move the camera to cause the confidence score to satisfy the threshold.

20. The camera of claim 19, wherein the second trained machine learning model is trained to minimize a distance between a center point of a field of view of the camera and a centroid of a bounding box circumscribing the object of interest, and wherein the direction is based on the distance.
